(19) United States
(12) Patent Application Publication
(10) Pub. No.: US 2024/0160719 A1
(43) Pub. Date: May 16, 2024

(54) INFORMATION PROCESSING SYSTEM

(71) Applicant: Preferred Networks, Inc., Tokyo-to (JP)

(72) Inventors: Masateru KAWAGUCHI, Tokyo-to (JP); Takuya OGATA, Tokyo-to (JP); Yuta TSUBOI, Tokyo-to (JP)

(73) Assignee: Preferred Networks, Inc., Tokyo-to (JP)

(21) Appl. No.: 18/505,229

(22) Filed: Nov. 9, 2023

(30) Foreign Application Priority Data
Nov. 11, 2022 (JP) 2022-180798

(51) Int. Cl. G06F 21/51

(52) U.S. Cl. CPC G06F 21/51

(57) ABSTRACT

An information processing system comprises at least one memory and at least one processor. The at least one processor is configured to receive a request of a user; determine whether or not to permit processing of the request based on a term of use of the user; and execute the processing using a neural network based on the request whose processing is determined as being permitted. The term of use includes a condition related to a structure of a processing target of the neural network.

### CROSS REFERENCE TO THE RELATED APPLICATIONS

This application is based upon and claims the benefit of priority from the Japanese Patent Application No. 2022-180798, filed on Nov. 11, 2022, the entire contents of which are incorporated herein by reference. Further, the entire contents of provisional U.S. application No. 63/209,419, filed on Jun. 11, 2021 and international application No. PCT/JP2022/023519, filed on Jun. 10, 2022, are incorporated herein by reference.

### FIELD

This disclosure relates to an information processing system.

### BACKGROUND

SaaS (Software as a Service) has been widely deployed as a means for providing, through an Internet line, various types of services using software implemented on a cloud server. Examples of SaaS include a service where a cluster as a computing server including accelerators such as GPUs (Graphics Processing Units) is provided on a cloud and high-speed computation using the GPUs is made available to users.

In the case where a service for handling processing from a plurality of clients is executed in such a GPU cluster, the processing is desirably controlled according to priority setting and data volume inputtable by each user so that resources can be stably and appropriately allocated according to a fee paid by each user. However, because of the wide variety of services in SaaS, consideration according to the contents of the service to be provided needs to be taken in deciding how the resources should be allocated.

### BRIEF DESCRIPTION OF THE DRAWINGS

FIG. 1 is a diagram schematically illustrating an example of an information processing system according to an embodiment.

FIG. 2 is a flowchart illustrating processes in the information processing system according to the embodiment.

FIG. 3 is a diagram schematically illustrating an example of an information processing system according to an embodiment.

FIG. 4 is a flowchart illustrating processes in the information processing system according to the embodiment.

FIG. 5 is a chart schematically illustrating an example of flow rate control according to the embodiment.

FIG. 6 is a diagram illustrating one example of an implementation of an information processing system/device according to an embodiment.

### DETAILED DESCRIPTION

According to one embodiment, an information processing system comprises at least one memory and at least one processor. The at least one processor is configured to receive a request of a user; determine whether or not to permit processing of the request based on a term of use of the user; and execute the processing using a neural network based on the request whose processing is determined as being permitted. The term of use includes a condition related to a structure of a processing target of the neural network.

According to one embodiment, an information processing device comprises at least one processing circuitry. The at least one processing circuitry is configured to process input data transmitted from a client at a processing speed based on flow rate set for each user with respect to amount of atoms in the input data.

Problems corresponding to the effects described in the embodiments can be several non-limiting examples. Specifically, a problem corresponding to at least any one of the effects described in the description of the embodiments of this disclosure can be a problem to be solved in this disclosure.

The embodiments of the present invention will be hereinafter described with reference to the drawings. The drawings and the description of the embodiments are only presented by way of example and do not limit the present invention. Further, numerical values presented in the description of the embodiments are shown by way of example, and the embodiments in this disclosure are not limited to the presented numerical values.

### First Embodiment

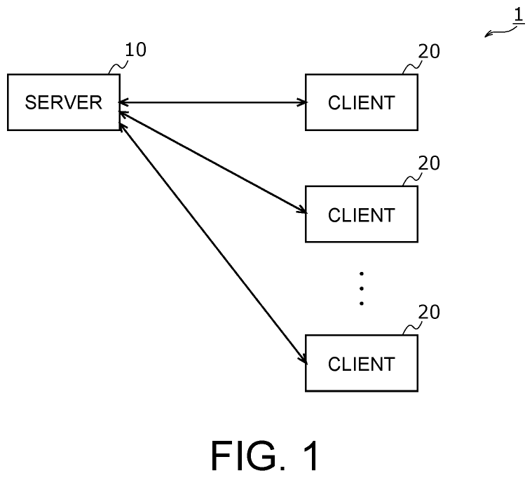

FIG. 1 is a diagram schematically illustrating an example of the outline of an information processing system according to one embodiment. The information processing system 1 includes a server 10 and a plurality of clients 20. The information processing system 1 is a system that executes predetermined computation in the server 10 based on computation requests input from the clients and outputs the computation results to the clients 20. The server 10 and the clients 20 are connected through a network such as the Internet.

In this disclosure, by way of non-limiting example, the information processing system 1 executes the processing of a neural network to which a graph is inputtable and outputs to a user. By way of more specific example, a system that executes NNP (Neural Network Potential) of outputting at least one of energy and force when a graph based on atomic information is input will be described.

Here, the atomic information only needs to contain information related to a plurality of atoms of a processing target, and it contains, for example, information related to the types and positions of the atoms. Examples of the information related to the positions of the atoms include information directly indicating the positions of the atoms by means of the coordinates and information directly or indirectly indicating the relative positions between the atoms. Further, the information related to the positions of the atoms may be information expressing the positional relationship between the atoms by means of the distance, angle, dihedral angle, or the like between the atoms. The atomic information may contain, besides the information related to the types and positions of the atoms, information related to electric charges, information related to the bond of the atoms, and information related to periodic boundary conditions, the size of a cell, and so on. The graph may be a graph where pieces of information related to the plurality of atoms are contained, and pieces of the information related to the atoms are nodes and connections of the atoms are edges.

In processing other than NNP as well, the mode in this disclosure may be applied to such computation that memory areas occupied by data to be processed and data during the computation are large on the same level as in this disclosure. For example, it may be applied to a system using a neural network that calculates another physical property value (physical property value other than energy or force) from the atomic information.

In the drawing, the single server 10 is connected to the plurality of clients 20, but the server 10 may be provided in plurality, and the single client 20 may be connected at a certain stage.

The server 10 is an information processing device that executes predetermined computation based on computation requests from the clients 20 (computation requests from users using the clients 20) and responds to the clients 20. The server 10 can include GPU as an accelerator, for instance. Besides, the server 10 may include an optional processor capable of high-speed parallel computation. The server 10 may include a cluster of computing units (for example, GPUs) present on a cloud.

The server configuration may be such that a structure not directly involved in speeding up the computation, such as a gateway server, a proxy server, or a load balancer, which is not illustrated in FIG. 1, is provided in addition to the aforementioned ones, and various requests are appropriately assigned to the servers which execute computation.

By way of example, the server 10 forms a neural network for executing NNP and forward propagates data related to the atomic information to this neural network to thereby obtain the value of energy. The server 10 is also capable of backward propagating the value of this energy to obtain force regarding the atoms. This is not restrictive, and the server 10 may obtain, by computing, a desired physical property value obtainable using NNP.

The neural network involved in NNP deployed in the server is a neural network capable of handling input graph data of various types. That is, the server 10 is capable of obtaining an appropriate physical property value by inputting, to the neural network, graphs corresponding to various types of atomic information input from the clients 20. The server 10 may have multiple types of neural networks and switch a neural network for use based on a computation request or a processing target from a user.

In the above, the graph data is transmitted from the clients 20, but this is not restrictive. Another mode may be to obtain the atomic information of the processing targets from the clients 20 and generate the graph data on the server 10 side. Besides, a different server for generating the graph data may be provided between the server 10 and the clients 20.

The server 10 outputs the obtained physical property values to the clients 20. Alternatively, the server 10 may output them not to the clients 20 but to an optional storage such as a file server on the cloud. In this case, the clients 20 can also be notified of the completion of the computation.

In the case where the information processing system 1 includes a plurality of GPUs as the server 10, the server 10 may be composed of GPUs having the same function and performance or may be configured to include GPUs having different functions and performances.

The clients 20 are information processing devices which are input/output interfaces used by the users. The server 10 executes computation based on user's computation requests input through the clients 20 and outputs the computation results to the clients 20.

As described above, an example of the computation executed by the server 10 is computation related to the acquisition of the physical property value using NNP. In this case, the client 20 accepts the atomic information from which the physical property value is desired to be measured and transmits the accepted information to the server 10 to request the computation, thereby capable of causing the execution of the computation desired by the user. In this manner, graphing the atomic information that the user requires or that is his/her study subject and inputting the graphed atomic information enables the user to obtain the physical property value such as energy or force.

As described above, this graphing may be executed in a device (such as the server 10) other than the clients 20.

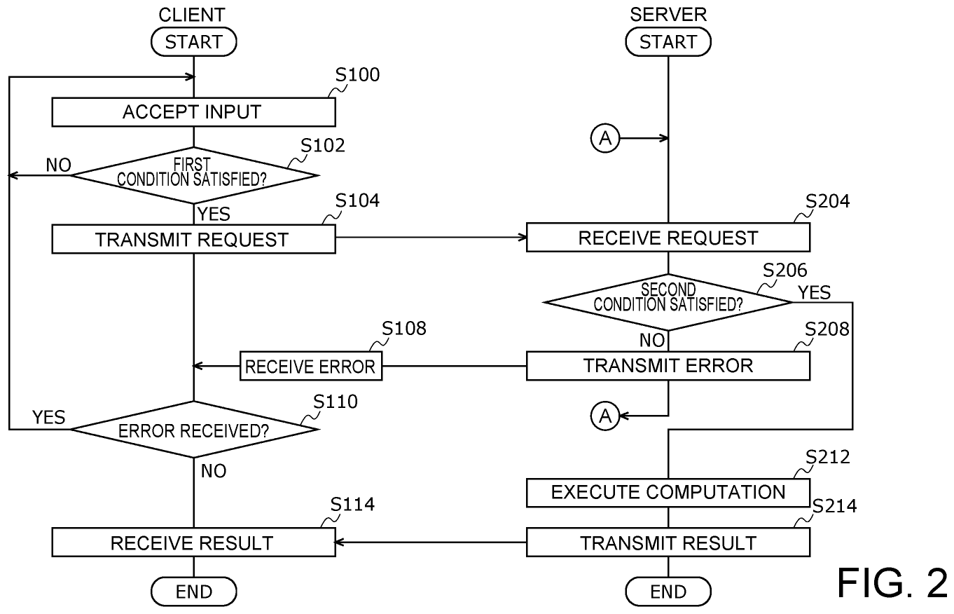

FIG. 2 is a flowchart illustrating an example of processes in the information processing system according to the embodiment. The left flow is the process in the clients 20 and the right flow is the process in the server 10.

The client 20 accepts information (input data) about a processing target from a user (S100). This input data is, for example, information about the processing target (a molecule, a plurality of atoms, or the like) whose physical property value is desired to be obtained. By way of example, the input data is atomic information. The atomic information can contain, for example, data on the types of the atoms and the coordinates indicating their positions in a three-dimensional space. The input data may further contain data related to an environment of the processing target and data related to the computation, such as boundary conditions or the like of the processing target.

The client 20 determines whether the accepted input data satisfies a first condition or not (S102). This first condition may be a condition regarding which the determination is done based on the number of atoms of the processing target which number is indicated by the input atomic information. The information processing system 1 may set, for example, the maximum value of the number of atoms the user is permitted to input, and the client 20 executes the determination in S102 by reading the number of atoms (the number of input atoms) of the processing target which number is indicated by the input atomic information.

If the first condition is not satisfied, for example, if the number of the input atoms exceeds the maximum number of atoms (S102: NO), the client 20 may return to a waiting state for data input. By way of another example, the client 20 may finish the process. Along with either of these processes, the client 20 may notify the user that the first condition is not satisfied, through an output interface such as a display.

If the first condition is satisfied, for example, if the number of the input atoms is equal to or less than the maximum number of atoms (S102: YES), the client 20 transmits a request for processing the accepted input data to the server 10 (S104). The client 20 can transmit the input data to the server 10 together with the computation request. By way of another example, another possible mode is that the client 20 transmits the input data to the file server such as a storage accessible by the server 10, and the server 10 obtains the input data at an appropriate time. Here, the computation request transmitted from the client 20 to the server 10 may contain the input data, or the server 10 may obtain the input data from the file server or the like based on the received computation request.

The server 10 receiving the computation request from the client 20 (S204) determines whether the input data satisfies a second condition or not (S206). The second condition may be a condition regarding which the determination is done based on the number of atoms neighboring the plurality of atoms included in the processing target (number of neighbors). The neighboring atoms refer to atoms regarded as neighboring the input atoms. The number of neighbors of each of the input atoms (nodes) can be, for example, the total number of relationships (edges) connected to nodes whose interconnection should be considered in the computation. For each user, the information processing system 1 can set the second condition, more specifically, can set the maximum value of the number of neighbors permitted to undergo computation, as is the case with the first condition.

For example, regarding nodes of interest, the server 10 sets their distance to neighboring nodes (by way of non-limiting example, the distance of 4 to 10 Å) and obtains the number of nodes present within the set distance from each of the nodes, through computation by GPU, thereby capable of obtaining the sum of the obtained numbers of nodes as the number of edges, that is, as the number of neighbors. The server 10 executes the determination in S206 based on whether or not the obtained number of neighbors exceeds the maximum number of neighbors.

Thus, the second condition can be a determination condition for which computation takes a lot of time if executed on the client 20 side but can be executed at a high speed if the accelerator on the server 10 side is used. On the other hand, the first condition can be a condition for which computation does not take a lot of costs even if executed on the client 20 side. The first condition can be, for example, a determination condition for which processing takes a lower cost when executed by the client 20, in consideration of the transmission of the computation request, the reception of a response, the waiting time in the server 10, and so on.

Though the determination using the second condition may be executed by the client 20 in S102, it is desirably executed by the server 10 as a pre-process of the computation related to NNP (for example, a process related to GNN: Graph Neural Network) as described above because there is a possibility that time cost and computational cost become high if it is executed on the client 20 side. Further, executing this on the server 10 side enables the high-speed execution of the search for the number of edges and also enables the appropriate determination even if the specifications of the neural network forming NNP change or the distance setting changes on the server 10 side.

If the input data does not satisfy the second condition (S206: NO), the server 10 transmits an error to the client 20 (S208). The server 10 can shift to a waiting state for the reception of a computation request from the client 20 as it transmits the error.

If the server 10 transmits the error, the client 20 receives the error (S108).

If receiving the error (S110: YES), the client 20 determines that the computation has not been executed in the server 10, and may shift to a waiting state for the acceptance of input data.

In the case where the server 10 transmits the error in S208, it may transmit a message (error code) to the effect that the number of neighbors of the input data exceeds the maximum number of neighbors, to the client 20 along with the error. By referring to this message, the client 20 is capable of obtaining the fact that the cause of the error is that the second condition is not satisfied and notifying the user of this.

Further, the server 10 may include, in this message, the maximum number of neighbors that the user is permitted to use and the number of the neighbors in the case where the inference is made from the input data. By knowing the number of neighbors for input data, the user is capable of easily generating appropriate input data for obtaining the result.

If not receiving the error (S110: NO), the client 20 determines that the computation for the input data is being executed in the server 10 and shifts to a waiting state for the server 10 to output the result.

As another implementation, the client 20 may shift to a result-receiving state from the server 10 after S104. In this case, after receiving the result from the server 10, the client 20 may return to the waiting state for the acceptance of input data if the result is an error. In the case where the client 20 receives not the error but a physical property value as the result, the client 20 may appropriately finish the process or return to the waiting state for the acceptance of input data after receiving the result. Further, in the case where continuous data have been input as a queue, the client may transmit the next computation request to the server 10. In this case, before inputting it to the queue, the client 20 may execute the determination on whether or not the first condition is satisfied (S102).

If the second condition is satisfied (S206: YES), the server 10 executes NNP computation based on the input data to obtain the physical property value requested from the client 20 (S212). The transmission of the error in S208 not only is executed after the determination in S206 but also can be executed for an error occurring during the execution of the computation in S212. In this case, the client 20 can receive the error occurring during the execution and its cause and so on from the server 10.

After completing the computation, the server 10 transmits, to the client 20, the physical property value which is the computation result (S214) to complete the process. Thereafter, the server 10 may shift to a waiting state for a new computation request.

As described above, the information processing system 1 forms a system involved in SaaS where the client 20 makes the computation request to the server 10 based on the atomic information which is the input data accepted by the client 20, and the computation result obtained through the processing in the server is output to the client 20.

The first condition and the second condition can be set for each user as described above. The information processing system 1 can set the first condition and the second condition according to, for example, a plan (a use plan of a SaaS-type service) set for each user.

The first condition and the second condition can be set according to, for example, a fee paid by each user. For example, the information processing system 1 can set both the maximum number of atoms and the maximum number of neighbors large for a user paying a high fee and set at least one of the maximum number of atoms and the maximum number of neighbors smaller for a user paying a lower fee than the fee paid by the aforesaid user.

As described hitherto, according to this embodiment, the information processing system 1 is capable of stabilizing the system and forming a system that executes computation on a more advantageous condition for a user paying a higher fee. For the user side as well, it is possible to pay an appropriate fee in consideration of the balance between performance and a fee that the user pays. A service implemented in SaaS is sometimes deployed for processing where the cost of calculation resources is mostly occupied by computation using resources such as GPU or a GPU memory. According to the embodiment in this disclosure, appropriate resource allocation based on the term of use set for each user is achieved. In sprits of the present disclosure, a phrase “term of use” includes a strictly and a not strictly meanings. The phrase can have a broad meaning, e.g., “conditions of use,” “promise to use,” “permission to use of plan,” or just “arrangement for the user to use,” etc.

For example, from a plurality of plans different in price, a user can select a service that he/she will receive. By way of non-limiting example, the information processing system 1 can set the maximum number of atoms to 10,000 and the maximum number of neighbors to 100,000 as a low-priced plan 1, set the maximum number of atoms to 20,000 and the maximum number of neighbors to 200,000 as a middle-priced plan 2, set the maximum number of atoms to 40,000 and the maximum number of neighbors to 400,000 as a high-priced plan 3, and so on.

In the above, the maximum number of atoms and the maximum number of neighbors both increase as the paid fee increases, but this is not restrictive. For example, in the plan 2, the maximum number of atoms can be set to 10,000 and the maximum number of neighbors can be set to 200,000, or by way of another example, the maximum number of atoms can be set to 20,000 and the maximum number of neighbors can be set to 100,000. That is, setting one of the maximum number of atoms and the maximum number of neighbors to the same value as that in a different plan is not excluded.

Note that the information processing system 1 may further set the maximum memory usage amount for each plan. In the NNP processing described above by way of example, what is important besides the maximum number of atoms and the maximum number of neighbors is that a memory capacity required during the execution is available. Therefore, the server 10 needs to avoid an OOM (Out of Memory) error during the execution. In light of this, the information processing system 1 can set the usable memory capacity as a plan determining factor. Naturally, in addition to this, the information processing system 1 may further limit the number of threads permitted to undergo simultaneous parallel computation.

The above-described embodiment may be implemented in the following non-limiting modification example. Naturally, a configuration that achieves the same processes, other than the above-described embodiment and the following modification example, is not excluded.

By way of example of this embodiment, the information processing system 1 executes the computation after executing the determinations using the first condition and the second condition. The determinations using these conditions each may be executed in the client 20, the server 10, or a gateway provided between the client 20 and the server 10. The gateway will be described in the following embodiment in detail.

By way of example, the server 10 side may execute both the first condition-based and second condition-based determinations. The server 10 obtains the first condition and the second condition according to a plan selected by the user. Similarly to the above, after the client 20 transmits the computation request, the server 10 may execute the first condition-based determination, and if the first condition is satisfied, may execute the second condition-based determination as the pre-process of the computation.

In the case where the server 10 manages computational tasks from one or more clients 20 using a queue, the server 10 may execute the first condition-based determination before enqueuing and transmit the determination result to the client 20. Executing this determination at this stage enables the client 20 to notify the user, at an early stage, that the first condition is not satisfied. Of course, the server 10 may execute the first condition-based determination at a stage after dequeuing.

By way of example, the gateway may execute at least one of the first condition-based and second condition-based determinations. In the case where a plurality of tasks are handled using a queue, the first condition-based determination may be executed at a stage either before queuing or after dequeuing as in the above. The notification to the client 20 can be executed at any stage after the determination.

In the case where the gateway executes the first condition-based determination and subsequently executes the second condition-based determination, or in the case where the client 20 executes the first condition-based determination and thereafter the gateway executes the second condition-based determination, the gateway can transmit, to the server 10, the result of the pre-process that it has executed for the second condition-based determination. The gateway may execute the second condition-based determination before enqueuing, but since the second condition-based determination takes a lot of costs, it may also employ a method of executing the determination after dequeuing or executing the second condition-based determination for the head task in the waiting line. By obtaining information about a plan selected by the user from the server 10, the gateway is capable of appropriately obtaining a condition regarding which the gateway is to execute the determination, out of the first condition and the second condition, and executing the process.

By way of example, in the case where the client 20 executes the first condition- or second condition-based determination, the client 20 can obtain from the server 10 the information about the plan selected by the user which information is stored in the server 10 in advance. By referring to the information about the plan, the client 20 is capable of executing the appropriate determination regarding the condition.

By way of example, the server 10 can execute the first condition-based determination. In the case where it executes the first condition-based determination, the server 10 is capable of appropriately executing the determination by referring to the plan selected by the user which plan is stored in the server 10. This also applies to the second condition-based determination.

By way of example, a unit set as a user may be an individual (natural person) or may be an organization (an organization of natural persons or a legal entity). A legal entity as an organization may be, for example, an organization such as an enterprise or a school.

By way of example, the plan may be set according to the type of a physical property value to be obtained. Further, the plan may be set according to the number of physical property values to be obtained. The user can select an appropriate plan according to the physical property value that he/she wants to obtain or the number of physical property values that he/she wants to obtain.

By way of example, the plan may be set according to which one of a plurality of models provided in the server 10 is used. The user can select the plan from the models implemented in the server 10 in consideration of a model that he/she will use.

By way of example, the pre-process executed in the server 10 (or the gateway) may include a process of constructing a graph that is to be input to the neural network based on the computation request from the client 20 or re-constructing the graph. The user can describe the atomic information of the processing target in a format designated by the client 20, and the server 10 can construct the graph from the atomic information conforming to this format.

Further, the user may input graph information in a format different from that used in constructing the graph to be processed by the server 10. By converting the format, the server 10 is capable of appropriately re-constructing the graph to the format for the input to the neural network. In this case, as for the first condition-based determination, the client 20 may extract the number of atoms from the format not yet converted, or as described above as the modification example, the gateway or the server 10 can obtain the number of atoms to execute the first condition-based determination after the conversion to the appropriate format.

By way of example, the pre-process executed in the server 10 (or the gateway) may include the server side executing, after the graph construction, the first condition-based determination and the second condition-based determination based on the constructed graph.

In the aforesaid GNN, the construction can mean, for example, constructing a graph that is to be input to GNN based on a user's request. Further, in another non-limiting example of the neural network, the construction can mean constructing information to be input to a neural network model for use, based on a user's request.

### Second Embodiment

The information processing system 1 can also receive computation requests from a plurality of users (the plurality of clients 20). In this case, as one component of the server 10, an information processing device that controls a queue may be provided. The computation requests from the plurality of clients 20 are controlled using the queue. Naturally, a plurality of computation requests from the same client 20 can also be controlled using this queue. In this embodiment, this control will be described.

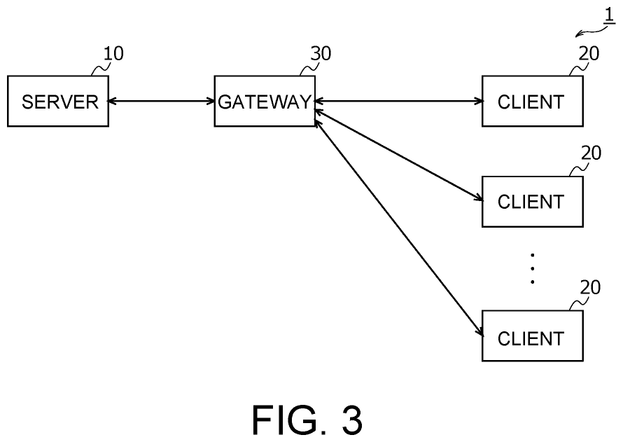

FIG. 3 is a diagram schematically illustrating an example of the outline of an information processing system 1 according to one embodiment. In addition to the information processing system 1 according to the above-described first embodiment, the information processing system 1 according to this embodiment further includes a gateway 30 that controls traffic from the clients to the server 10.

The gateway 30 is an information processing device that controls the flow rate of the processing in the server 10, regarding computation requests transmitted from the clients 20. The gateway controls the execution of computation by the server 10, based on the flow rate set for each user. The gateway 30 may be a proxy server.

The flow rate is decided according to a plan set for each user similarly to the maximum number of atoms and the maximum number of neighbors described in the above-described embodiment. By limiting the flow rate, the control is executed so that unfair processing is eliminated in each plan set for users. The flow rate may be one representing a processing speed, a processing volume (computational resources used) per predetermined time (including unit time), or the like.

The gateway 30 can limit the computational resources used by the server 10, using various algorithms for flow rate limiting. Note that the server 10 may be configured to output the processing result directly to the client 20 not through the gateway 30.

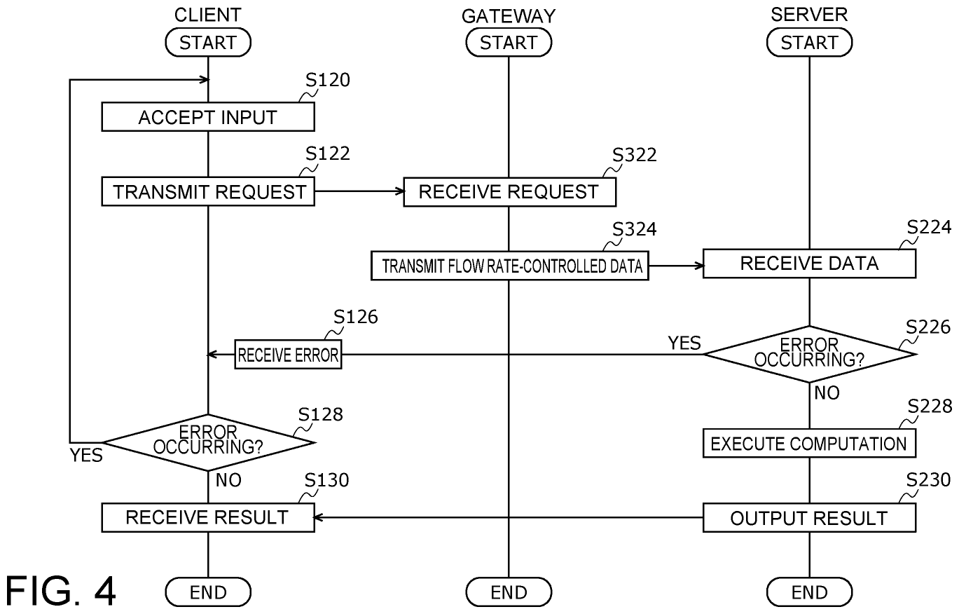

FIG. 4 is a flowchart illustrating processes in the information processing system 1 of the embodiment.

Upon accepting information (input data) about a processing target from a user (S120), the client 20 transmits, to the gateway 30, a computation request for the execution of the processing of the input data by the server 10 (S122). Before transmitting the computation request, the client 20 may execute the determination using the first condition set for each user, which determination is described in the above embodiment.

The gateway 30 receives the computation request transmitted by the client 20 (S322). The gateway 30 may prepare a queue in advance, enqueue the received computation request, and dequeue the computation request according to the flow rate control that is based on the number of atoms.

The gateway 30 transmits the data controlled based on the flow rate control (the computation request based on the flow rate limiting) to the server 10 (S324). An example of the flow rate control will be described in detail later.

The server 10 receives the input data through the gateway 30 (S224). As in the above-described embodiment, the input data itself may be obtained through the storage provided in the information processing system 1. Here, the input data may be contained in the computation request transmitted from the gateway to the server 10, or the server 10 may obtain the input data from the storage or the like based on the received computation request.

If an error occurs (S226: YES), the server 10 transmits an error to the client 20. If the error is transmitted from the server 10, the client 20 receives the error (S126). For example, the server may determine whether or not an error has occurred, by executing the determination using the second condition set for each user, which determination is described in the above-described embodiment.

The server 10 executes computation (S228). As in the above-described embodiment, the server 10 executes the computation of obtaining a physical property value by inputting a graph that is based on the atomic information transmitted from the client 20, to a neural network involved in NNP. If an error occurs during the execution, the server 10 may also return an error to the client 20.

After inferring the physical property value, the server 10 outputs the obtained result to the client 20 (S230). The client 20 receives the inference result output from the server 10 (S130), and can appropriately execute a subsequent process thereafter.

Thus, owing to the intermediary gateway 30, the information processing system 1 is capable of causing the server 10 to execute appropriate processing after controlling the flow rate of the input data transmitted from the client 20.

The appropriate flow rate control enables the fair execution of processing for each user. As in the above-described embodiment, the user is capable of selecting a service to be received, from a plurality of plans different in price, for instance. By setting the flow rate higher in a plan whose fee is higher, the information processing system 1 is capable of providing the fair use of the server to users selecting the same plan.

For example, let us consider the case in the above-described first embodiment where plans are sorted according to the first condition and the second condition. Out of users selecting the same plan, a user inputting data having a large number of atoms within the range of the set maximum number of atoms is possibly given a larger resource quota than that given to a user inputting data having a smaller number of atoms. In this case, the user inputting the data having the smaller number of atoms may feel a sense of unfairness.

Here, executing the flow rate limiting to limit the number of atoms permitted to undergo processing per predetermined time (including unit time) makes it possible to reduce a sense of unfairness among users selecting the same plan.

Next, the flow rate control will be described while providing examples. By executing the flow rate limiting, the information processing system 1 is capable of more fairly allocating GPUs and GPU memories usable as computational resources to users. The gateway 30 manages one queue, and enqueues and decueues the computation requests received from the clients 20, to/from this queue based on the flow rate limit set for each user, whereby the computation using a plurality of GPU cores is executed.

By way of non-limiting example, the gateway 30 can execute the flow rate control based on the token bucket algorithm.

For example, the gateway 30 has buckets for the respective clients 20 connected thereto. In this bucket, a token is added at a rate according to a plan selected by the user. For example, the token may be information based on information related to structure (the number of atoms or the like).

The gateway 30 may add one token to the bucket every 1/r second according to the plan or may add r pieces of tokens to the bucket every one second according to the plan. More specifically, (one token)=(one atom) may be set, and the gateway 30 adds, to the bucket, tokens that enable the computation of one atom every 1/r second or the computation of r pieces of atoms every one second, for instance.

Further, the gateway 30 can also change the size of the bucket according to the plan selected by the user. The size of the bucket may be decided based on the number of atoms stipulated in the plan.

When the user transmits the computation request through the client 20, the gateway 30 enqueues the computation request transmitted from the client 20. The gateway 30 may enqueue a plurality of computation requests from the same user. The gateway 30 compares the number of atoms of a processing target which number is specified in the computation request stored at the head of the queue and the number of atoms permitted to undergo computation which number is based on the tokens currently held in the bucket.

If the number of atoms based on the tokens held in the bucket is equal to or more than the number of the atoms of the processing target, the gateway 30 dequeues the computation request. If the number of the atoms of the input data is larger, the gateway 30 keeps the computation request pending until the number of atoms permitted to undergo computation which number is based on the tokens held in the bucket reaches the number of the atoms of the processing target or more.

By way of another example, if the token amount is insufficient, the gateway 30 may return an error to the client 20 instead of putting the computation request in the pending state. The client 20 is capable of executing a process of requesting a retry after token recovery in a cool time.

The gateway 30 may include FIFO (First In First Out) for each of the clients 20 connected thereto, and based on the tokens held in the bucket, may be configured to forward a computational task from this FIFO to the queue from which the computation request is forwarded to the server 10. That is, the gateway 30 may manage queues which are provided for the respective clients 20 to hold computation requests from the clients 20 and one queue from which the computation requests are forwarded to the server 10.

The server 10 appropriately dequeues the computation requests enqueued by the gateway 30 to sequentially execute computation. In the case where it has a plurality of GPUs, by appropriately assigning the computation requests to them, it is possible to process the computation requests from the plurality of clients 20 in parallel.

For example, the server 10 may ask the gateway 30 whether or not a processable computation request is currently present. If the processable computation request is present, the server 10 obtains data related to this computation request and is capable of starting computational processing.

Such flow rate limiting enables the setting of the number of atoms permitted to undergo processing per second in each plan.

By way of specific example, without the flow rate limiting, if a user A who has put 2000 atoms and a user B who has put 1000 atoms request the computation for these data simultaneously, the computation results are obtained at the same time. As a result, even in the case where plans selected by them are the same, the amount of computational resources used per time for the user A is larger, and nevertheless, the user B pays the same fee as that paid by the user A.

On the other hand, with the above flow rate limiting, in the case where the aforesaid user A and user B input the data simultaneously, the information processing system 1 executes the computational processing for the user B at a stage when tokens corresponding to 1000 atoms are held. At this stage, the computational processing for the user A is kept on standby. As in the above, an error may be returned instead of keeping the computational processing on standby. If receiving the error, the client 20 can make a retry after waiting until token recovery. The computational processing for the user A is executed at a stage when tokens corresponding to 2000 atoms are held, that is, after a waiting time twice as long as the computation waiting time of the user B.

As a result, it is possible to make the number of atoms processed per time equal among users selecting the same plan. Naturally, the user B may input data corresponding to 1000 atoms continuously, in which case, the computation time required for the data input by the user A and the computation time required for the data input by the user B can be substantially equal if overhead is ignored. Thus, it is possible to eliminate a sense of unfairness among users selecting the same plan.

It has been described that the above-described flow rate control process is executed in the gateway 30, but this is not restrictive. An example of implementation can be that the client 20 side executes the control using software (application) or API (Application Program Interface) used for transmitting a computation request and transmits the computation request to the gateway 30 at a stage when an appropriate amount of tokens are held. In this case, the gateway 30 may perform a consistency check for confirming if the computation request transmitted by the client 20 is based on appropriate token-based control. In such implementation, a queue for transmitting the computation request to the gateway 30 can be held on the client 20 side, resulting in a reduction in computational processing in the gateway 30, and in the case where the client 20 transmits computation requests continuously, this makes it possible for the client 20 to achieve the deletion of an untransmitted request, the replacement of it by another request, or the like without any consideration of communication delay or the like.

The above describes the example where a burst is allowed and the computation is requested at a stage when tokens corresponding to the number of atoms to be processed accumulate, but this is not restrictive. As in a typical token bucket model, the mode where data corresponding to the flow rate per unit time is transmitted from the gateway 30 to the server 10 may be employed.

The outline of a process in this example will be described.

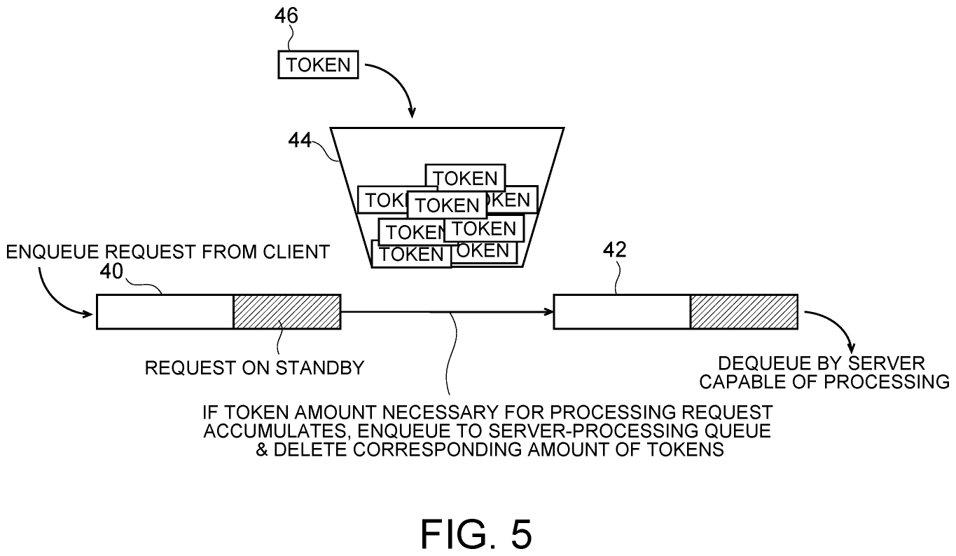

FIG. 5 is an explanatory chart of an example of flow rate control according to one embodiment.

The information processing system 1 can use the aforesaid token bucket-based method or a different flow-rate control algorithm. A used algorithm may be any algorithm as long as it achieves a process of (1) periodically giving a token, (2) passing a user's computation request if tokens are left, and (3) if the tokens are not left, holding the user's computation request in a queue.

According to a plan selected by a user, the information processing system 1 can set at least one of (A) a first token amount added to the user per predetermined time (including unit time), (B) a second token amount the user is permitted to possess (for example, in the token bucket model, the size of the bucket), and (C) a third token amount the user is permitted to consume per predetermined time (including unit time).

As illustrated in FIG. 5, the gateway 30 has first queues provided for the respective clients 20 (may be provided for respective users) and a second queue 42 from which the server 10 dequeues a task. The first queues 40 are not essential components. By way of another example, the first queues 40 may be provided in the clients 20.

The gateway 30 refills a virtual bucket 44 with one token 46 every predetermined time or with a predetermined number of tokens 46 every unit time (token recovery). A parameter related to this recovery amount corresponds to (1), (A) described above. The maximum amount of the tokens 46 accumulatable in the bucket 44 corresponds to (B).

In the case where the first queue 40 is provided, computation requests from the client 20 are stored as a waiting line in the first queue 40. If the necessary amount of tokens for processing the head one in the waiting line is held in the bucket 44, the gateway 30 dequeues this computation request from the first queue 40 and enqueues it to the second queue 42 for the processing by the server 10. This process corresponds to the aforesaid process (2). The server 10 obtains the computation request enqueued in the second queue 42, at a stage when the server 10 is capable of processing it, and executes the computation.

In the case where the gateway 30 does not have the first queues 40, upon receiving a computation request from the client, the gateway 30 determines whether or not the necessary amount of the tokens 46 for processing this computation request is held in the bucket 44.

If the token amount is sufficient, the gateway 30 enqueues the computation request received from the client 20 to the second queue 42. This process corresponds to (2) described above.

If the token amount is not sufficient, the gateway 30 returns to the client 20 an error to the effect that the processing is not permitted due to the flow rate limiting and may discard the received computation request. In this case, the client 20 can retry the request transmission to the gateway 30 after waiting for token recovery. This process corresponds to (3) described above.

Even in the case where the token amount is sufficient, it is possible not to permit the computation request from the client 20 based on the aforesaid parameter (C). For example, the gateway can implement this process by controlling the permitted amount of tokens used per unit time.

By way of non-limiting example, the token described above can be the number of atoms or a value based on the number of atoms. Further, the token may be another value influencing computational resources using the neural network. By way of non-limiting example, in the case where the server 10 executes the processing of a graph-related neural network, the token can be the number of nodes of a graph to be processed or can be a value in which the number of edges is taken into consideration. Besides, the token can be set as a value corresponding to a processing volume in the server 10 or a memory amount used (used/occupied resource amount), based on a neural network used.

In any of the examples, the information processing system 1 can set the token-related amounts for a user selecting a high-priced plan to be large. Such a setting can enhance user satisfaction.

In the above, it is not excluded that at least one of the token-related amounts in a high-priced plan and the corresponding one of the token-related amounts in a low-priced plan have the same value.

In this embodiment, the user may be notified of a usable resource (token amount) through the client 20. This notification can also take any form providing an easy understanding to the user, such as numerical or graph representation of the remaining usable number of atoms, its percentage, or the like.

As described hitherto, according to this embodiment, it is possible to execute the control not producing an unfair state in each plan. By the gateway 30 controlling the computation requests from all the clients 20 using the queues, the server 10 is capable of achieving appropriate computational processing that is based on the flow rate control.

For this flow rate limiting, a model other than the token bucket model is usable. For example, for the flow rate limiting, a leaky bucket model may be used.

Note that FIG. 4 illustrates that the client 20 returns an error only when receiving the notification from the server 10, but this is not restrictive. For example, when receiving, from the gateway 30, an error to the effect that the flow rate limit is exceeded, the client 20 may notify the user of the error. The client 20 may notify the gateway 30 that data exceeding the flow rate limit will be retried. Since a token is possibly added to the bucket during the retry, there is a possibility that the flow rate limiting can be overcome after the retry. The client 20 can also notify the user of an error to the effect that the processing is not permitted, after a retry is executed a predetermined number of times. For example, if input data kept pending is present at a stage of the transmission to the gateway 30, the client 20 can return an error.

As previously described, the first embodiment and the second embodiment can be used in combination. Combining them makes it possible to set more flexible limitations for each plan.

Further, the processes in this disclosure are not limited to be implemented for NNP, and for example, can be implemented in SaaS that executes computation by GNN. Further, in other SaaS processing as well, the processes in this disclosure are applicable to a service where computation influencing memory size is executed.

Further, the gateway 30 can manage the queues using at least one memory.

Further, in the information processing system 1, the term of use of each user is stored in at least one memory, for example, a plan selected by the user and conditions linked to the plan are stored in a storage (storage circuit).

The information processing system 1 in this disclosure can have any configuration enabling the appropriate processing, other than the configurations in the above-described embodiments.

The information processing system 1 may be configured to include one server 10 or more, for instance. The information processing system 1 may implement the functions described in the above-described embodiments, using this configuration.

The information processing system 1 may be configured to include one server 10 or more and one gateway 30 or more, for instance. The information processing system 1 may implement the functions described in the above-described embodiments, using this configuration.

The information processing system 1 may be configured to include one server 10 or more, one gateway 30 or more, and one client 20 or more, for instance. The information processing system 1 may implement the functions described in the above-described embodiments, using this configuration.

The information processing system 1 may be configured to include one server 10 or more and one client 20 or more, for instance. The information processing system 1 may implement the functions described in the above-described embodiments, using this configuration.

In this disclosure, a user may be an individual, an organization, or a member of an organization. The organization may be an enterprise or a school, for instance. In the information processing system 1, the users may be managed using identifiers. In the information processing system 1, for example, the identifier of the user is transmitted from the client 20 to the server 10 or the gateway 30, and a request from the client 20 can be appropriately processed.

In this disclosure, the determination on whether the processing is to be executed (determination on whether or not to permit processing), which determination is executed by at least one processor, is a concept including at least a determination on whether or not to permit the acceptance of a request (acceptance necessity), whether or not to permit the acceptance of data (acceptance necessity), whether or not to permit the execution of processing based on the request (execution necessity), or whether or not the request conforms to the term of use set for the user. The determination that the processing is permitted as a result of the above is a concept including a determination that the acceptance of the request is permitted (acceptance is necessary), that the acceptance of the data is permitted (acceptance is necessary), the execution of the processing based on the request is permitted (execution is necessary), or that the request conforms to the term of use set for the user.

In this disclosure, the processing using the neural network includes, by using NNP, calculating at least one of force and energy and calculating other physical property value or the like regarding the processing target, as are shown in the above-described embodiments by way of non-limiting examples. It also includes calculating one type of analytical value or more regarding the processing target using one neural network or more.

Further, by way of non-limiting example, the processing using the neural network can include processing of executing classification or the like of the processing target using the neural network.

Further, in the above description, as the neural network, the graph neural network is used as an example, but this is not restrictive, and it may be a model having in at least part a model of any form such as CNN (Convolutional Neural Network) or MLP (Multi-Layer Perception).

In this disclosure, a request from a user/user's request may be a request for computation using the neural network as described in the above embodiments. Further, this request may contain information about the target to be processed by the neural network. By way of example, it may contain atomic information, information indicating the structure of the processing target, or information indirectly indicating the structure of the processing target. Naturally, it may contain other information for use in the processing.

In this disclosure, the term of use can be a higher-level concept of the first condition, the second condition, and the condition related to the flow rate control which are described in the embodiments. That is, the term of use may be any term decided according to a subscription plan or the like of the user, and for example, it may be any term as long as it includes one or more of the first condition, the second condition, and the condition related to the flow rate control which are described in the embodiments. Further, the term of use includes a condition related to structure which will be described later.

In this disclosure, the processing target may be a plurality of atoms, a molecule, a crystal, a compound, a substance, an object, or the like. Further, the processing target may be information indirectly indicating a plurality of atoms, a molecule, a crystal, a compound, a substance, an object, or the like. Further, the processing target may be information input to the neural network, for example, a graph. Further, the processing target may be a subject to be analyzed using the neural network.

In this disclosure, the condition related to structure may be a concept including the following conditions related to the structure of the processing target. The condition related to structure may be, for example, a condition using one of the following examples or may be a combined condition of the plurality of conditions. One of the various conditions listed in the above-described embodiments can be replaced by any of the following conditions.

An example of the condition may be a condition related to the number of atoms of the processing target (for example, the total number of atoms or the number based on the number of predetermined partial atoms). The condition related to the number of atoms may be information such as the number of atoms, the number of graph nodes decided based on the number of atoms, information presenting the same value as the number of atoms, the number of graph nodes decided based on the number of atoms, information presenting the same value as the number of atoms, information indirectly indicating the number of atoms, or information proportional to the number of atoms.

An example of the condition may be a condition related to the number of neighbors of the atoms of the processing target (for example, may be the total number of neighbors or may be the number based on the number of predetermined partial neighbors). The condition related to the number of neighbors may be information such as the number of neighbors of atoms, the number of graph edges decided based on the number of neighbors of the atoms, information presenting the same value as the number of neighbors of atoms, information indirectly indicating the number of neighbors of atoms, or information proportional to the number of neighbors of atoms.

An example of the condition may be a parameter influencing the computational resources (resources such as GPU or GPU memory) using the neural network. The parameter influencing the resources using the neural network may be the type of the neural network, the types of elements included in the processing target (the number of types), the spatial size of the processing target, the number of electrons, the number of protons, the number of neutrons, the quantity of atoms, information presenting the same value as any of the aforesaid pieces of information, information indirectly indicating any of the aforesaid pieces of information, information proportional to any of the aforesaid pieces of information, or the like.

In the above, the neural network is described as an example, but the embodiments described in this disclosure are also applicable to computation using a different model or algorithm. Further, in these cases, it is possible to set plans using the computation time for a user's request or elements influencing computational resources.

In this disclosure, the token amount may be information used for the control of resources available to each user. Further, it may be one directly or indirectly indicating the number of tokens.

In this disclosure, the request amount may indicate the number of requests. Further, the request amount may directly or indirectly indicate the amount of the processing target (or the number of the processing targets) of the neural network.

By way of example of the control of the request amount, information related to structure may be used. This information related to structure may include at least one of the following non-limiting examples or may be a combination of some of the following examples.

By way of example of the information related to structure, information related to the number of atoms (for example, the number of atoms, the number of graph nodes decided based on the number of atoms, information presenting the same value as the number of atoms, information indirectly indicating the number of atoms, information proportional to the number of atoms, or the like) may be used.

By way of example of the information related to structure, information related to the number of neighbors of atoms (for example, the number of neighbors of atoms, the number of graph edges decided based on the number of neighbors of atoms, information presenting the same value as the number of neighbors of atoms, information indirectly indicating the number of neighbors of atoms, information proportional to the number of neighbors of atoms, or the like) may be used.

By way of other non-limiting examples other than the aforementioned ones of the information related to structure, the number of types of elements, the number of electrons, the number of protons, the number of neutrons, the quantity of atoms, information presenting the same value as any of these pieces of information, information indirectly indicating any of these pieces of information, or information proportional to any of these pieces of information may be used. Further, information that is used for expressing the structure of the processing target in the neural network may be used. Further, information capable of directly or indirectly indicating the amount of the processing target (the number of the processing targets) of the neural network may be used.

The first token, second token, or third token amount described above may be set as a value directly or indirectly indicating the information related to structure. Further, this amount may be set by means of a predetermined function using the information related to structure or may be set to be proportional to the information related to structure. In short, the first token, second token, or third token amount may be set based on the information related to structure.

The information related to structure used in the control of the request amount may be decided based on the term of use of each user. Further, the information related to structure used in the control of the request amount may be linked with the term of use of the user.

The term of use of each user may include the information related to structure used in the control of the request amount. For example, what is necessary is to set the request amount processable for a user whose subscription is higher-priced to be larger than that for a user whose subscription is lower-priced.

The first token amount set for a user can be limited according to a subscription plan. For example, a first token amount of a user selecting a certain plan can be set equal to or larger than a first token amount set for a user selecting a lower-priced plan.

Similarly, a second token amount of a user selecting a certain plan can be set equal to or larger than a second token amount set for a user selecting a lower-priced plan, for instance. A third token amount of a user selecting a certain plan can be set equal to or larger than a third token amount set for a user selecting a lower-priced plan, for instance.

Assuming that there are provided a low-priced plan 1 whose term of use of a user stipulates the maximum number of atoms as 10,000 and the maximum number of neighbors as 100,000, a middle-priced plan 2 whose term of use of a user stipulates the maximum number of atoms as 20,000 and the maximum number of neighbors as 200,000, and a high-priced plan 3 whose term of use of a user stipulates the maximum number of atoms as 40,000 and the maximum number of neighbors as 400,000. In this case, the information processing system 1 may set the first to third token amounts in the plan 3 equal to or larger than the first to third token amounts in the plan 1 and the plan 2. Further, the term of use of a user may directly or indirectly set the first to third token amounts. Further, the first to third token amounts may be set based on the other conditions included in the term of use of each plan. Further, the condition used in the control of the request amount may be set based on the condition in the first embodiment.

Owing to such a setting, the information processing system 1 is capable of providing a better computational environment to a user selecting a high-priced plan than to a user selecting a lower-priced plan.

The embodiments of the present disclosure could be summarized, for example, as follow.

(1) An information processing system comprising: at least one memory, and at least one processor, wherein the at least one processor is configured to receive a request of a user, determine whether or not to permit processing of the request based on a term of use of the user, and execute the processing using a neural network based on the request whose processing is determined as being permitted, and wherein the term of use includes a condition related to a structure of a processing target of the neural network.

(2) The information processing system according to (1), wherein the term of use may include at least either a condition related to the number of atoms of the processing target, or a condition related to the number of neighbors of the atoms of the processing target.

(3) The information processing system according to (2), wherein the number of atoms in the term of use of the user may be equal to or more than the number of atoms in a term of use of another user subscribing to a service using the neural network with a plan lower in price than a plan of the user, and wherein the number of neighbors of the atoms in the term of use of the user may be equal to or more than the number of neighbors of atoms in the term of use of the other user.

(4) The information processing system according to any one of (1)-(3), wherein the at least one processor may be configured to construct information that is to be input to the neural network, based on the request, and determine whether or not to permit the processing of the request, based on the constructed information and the term of use.

(5) The information processing system according to (4), wherein the constructed information may be a graph.

(6) The information processing system according to any one of (1)-(5), wherein the neural network may be a graph neural network.

(7) The information processing system according to any one of (1)-(6), wherein the neural network may be a model of NNP.

(8) The information processing system according to any one of (1)-(7), wherein the term of use of the user may be set based on a type of the neural network.

(9) The information processing system according to any one of (1)-(8), wherein the at least one processor may be configured to receive a plurality of requests from the user; store the plurality of requests in the at least one memory, and control an amount of a request for which the processing using the neural network is to be executed, out of the plurality of requests stored in the at least one memory, based on information related to structure.

(10) The information processing system according to (9), wherein the information related to structure may include at least either information related to the number of atoms or information related to the number of neighbors of the atoms.

(11) An information processing system comprising: at least one memory, and at least one processor, wherein the at least one processor is configured to receive a plurality of requests from a user, store the plurality of requests in the at least one memory, and control an amount of a request for which processing using a neural network is to be executed, out of the plurality of requests stored in the at least one memory, and wherein the amount of the request is controlled based on information related to structure.

(12) The information processing system according to (11), wherein the information related to structure may include at least either information related to the number of atoms or information related to the number of neighbors of the atoms.

(13) The information processing system according to (11) or (12), wherein the amount may be controlled using at least one of a first token amount added to the user in a predetermined time, a second token amount the user is permitted to possess, and a third token amount the user is permitted to consume in a predetermined time.

(14) The information processing system according to (13), wherein the first token amount may be a value based on the information related to structure, wherein the second token amount may be a value based on the information related to structure, and wherein the third token amount may be a value based on the information related to structure.

(15) The information processing system according to (14), wherein the information related to structure may include at least either information related to the number of atoms or information related to the number of neighbors of the atoms.

(16) The information processing system according to (14) or (15), wherein the first token amount set for the user may be equal to or more than a first token amount set for another user subscribing to a service using the neural network with a plan lower in price than a plan of the user, wherein the second token amount set for the user may be equal to or more than a second token amount set for the other user, and wherein the third token amount set for the user may be equal to or more than a third token amount set for the other user.

(17) The information processing system according to (11)-(16), wherein the neural network may be a graph neural network.

(18) The information processing system according to (17), wherein the graph neural network may be a model of NNP.

The trained models of above embodiments may be, for example, a concept that includes a model that has been trained as described and then distilled by a general method.

Some or all of each device (the information processing device or an information processing device which is belonging to the information processing system 1) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

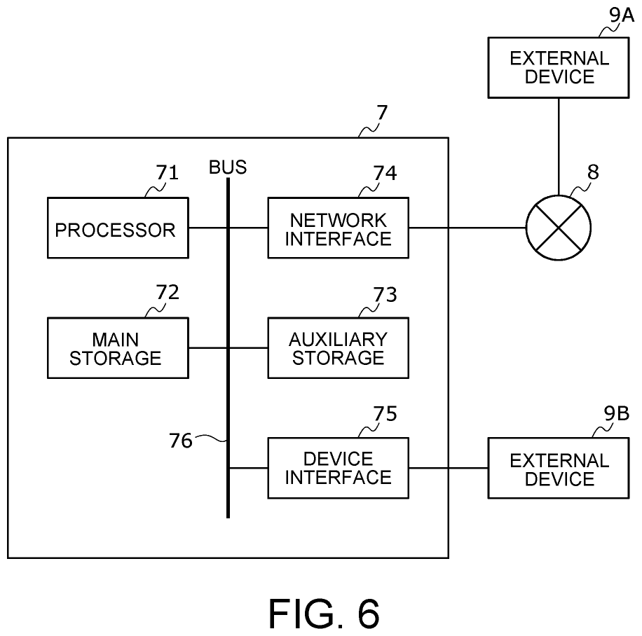

FIG. 6 is a block diagram illustrating an example of a hardware configuration of each device (the information processing device or the information processing device which is belonging to the information processing system 1) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 6 is provided with each component one by one but may be provided with a plurality of the same components. Although one computer 7 is illustrated in FIG. 6, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (the information processing device or the information processing device which is belonging to the information processing system 1) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (the information processing device or the information processing device which is belonging to the information processing system 1) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuitry, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (the information processing device or the information processing device which is belonging to the information processing system 1) in the above embodiments may be enabled by one or more processors 71. The processor 71 may refer to one or more electronic circuits located on one chip, or one or more electronic circuitries arranged on two or more chips or devices. In the case of a plurality of electronic circuitries are used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (the information processing device or the information processing device which is belonging to the information processing system 1) in the above embodiments may be enabled by the main storage device 72 or the auxiliary storage device 73 or may be implemented by a built-in memory built into the processor 71. For example, the storages in the above embodiments may be implemented in the main storage device 72 or the auxiliary storage device 73.

In the case of each device (the information processing device or the information processing device which is belonging to the information processing system 1) in the above embodiments is configured by at least one storage device (memory) and at least one of a plurality of processors connected/coupled to/with this at least one storage device, at least one of the plurality of processors may be connected to a single storage device. Or at least one of the plurality of storages may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (the information processing device or the information processing device which is belonging to the information processing system 1) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrically connection/coupling,” “communicatively connection/coupling,” “operatively connection/coupling,” “physically connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing system comprising:
at least one memory; and
at least one processor,
wherein the at least one processor is configured to:
receive a request of a user;
determine whether or not to permit processing of the request based on a term of use of the user; and
execute the processing using a neural network based on the request whose processing is determined as being permitted, and
wherein the term of use includes a condition related to a structure of a processing target of the neural network.

2. The information processing system according to claim 1,
wherein the term of use includes at least one of a condition related to the number of atoms of the processing target or a condition related to the number of neighbors of atoms of the processing target.

3. The information processing system according to claim 2,
wherein the condition related to the number of atoms represents a maximum number of atoms that the user is permitted to input into the neural network, and the condition related to the number of neighbors represents a maximum number of neighbors that the user is permitted to input into the neural network.

4. The information processing system according to claim 2,
wherein the number of atoms in the term of use of the user is equal to or more than the number of atoms in a term of use of another user subscribing to a service using the neural network with a plan lower in price than a plan of the user, and
wherein the number of neighbors of atoms in the term of use of the user is equal to or more than the number of neighbors of atoms in the term of use of the another user.

5. The information processing system according to claim 1,
wherein the at least one processor is configured to:
construct information that is to be input to the neural network, based on the request; and
determine whether or not to permit the processing of the request, based on the constructed information and the term of use.

6. The information processing system according to claim 4,
wherein the constructed information is a graph.

7. The information processing system according to claim 1,
wherein the neural network is a model of NNP.

8. The information processing system according to claim 1,
wherein the term of use of the user is set based on a type of the neural network.

9. The information processing system according to claim 1,
wherein the at least one processor is configured to:
receive a plurality of requests from the user;
store the plurality of requests in the at least one memory; and
control an amount of a request for which the processing using the neural network is to be executed, out of the plurality of requests stored in the at least one memory, based on information related to structure.

10. The information processing system according to claim 9,
wherein the information related to structure includes at least one of information related to the number of atoms or information related to the number of neighbors of atoms.

11. An information processing system comprising:
at least one memory; and
at least one processor,
wherein the at least one processor is configured to:
receive a plurality of requests from a user;
store the plurality of requests in the at least one memory; and
control an amount of a request for which processing using a neural network is to be executed, out of the plurality of requests stored in the at least one memory, and
wherein the amount of the request is controlled based on information related to structure.

12. The information processing system according to claim 11,
wherein the information related to structure includes at least one of information related to the number of atoms or information related to the number of neighbors of atoms.

13. The information processing system according to claim 11,
wherein the amount is controlled using at least one of a first token amount added to the user in a predetermined time, a second token amount the user is permitted to possess, or a third token amount the user is permitted to consume in a predetermined time.

14. The information processing system according to claim 13,
wherein the first token amount is a value based on the information related to structure,
wherein the second token amount is a value based on the information related to structure, and
wherein the third token amount is a value based on the information related to structure.

15. The information processing system according to claim 14,
wherein the information related to structure includes at least one of information related to the number of atoms or information related to the number of neighbors of atoms.

16. The information processing system according to claim 14,
wherein the first token amount set for the user is equal to or more than a first token amount set for another user subscribing to a service using the neural network with a plan lower in price than a plan of the user,
wherein the second token amount set for the user is equal to or more than a second token amount set for the another user, and
wherein the third token amount set for the user is equal to or more than a third token amount set for the another user.

17. The information processing system according to claim 11,
wherein the graph neural network is a model of NNP.

18. An information processing method comprising:
receiving, by at least one processor, a request of a user,
determining, by the at least one processor, whether or not to permit processing of the request based on a term of use of the user; and
executing, by the at least one processor, the processing using a neural network based on the request whose processing is determined as being permitted, and
wherein the term of use includes a condition related to a structure of a processing target of the neural network.

19. The information processing method according to claim 18,
wherein the permission to use includes at least one of a condition related to the number of atoms of the processing target or a condition related to the number of neighbors of atoms of the processing target.

20. An information processing method comprising:
receiving, by at least one processor, a plurality of requests from a user;
storing, by the at least one processor, the plurality of requests in at least one memory; and
controlling, by the at least one processor, an amount of a request for which processing using a neural network is to be executed, out of the plurality of requests stored in the at least one memory, and
wherein the amount of the request is controlled based on information related to structure.
